(19) United States
(12) Patent Application Publication
(10) Pub. No.: US 2022/0258353 A1
(43) Pub. Date: Aug. 18, 2022

(54) Calibration Method

(71) Applicant: Seiko Epson Corporation, Tokyo (JP)

(72) Inventors: Kentaro TSUKAMOTO, Azumino (JP); Kazuki HORIUCHI, Matsumoto (JP); Kenji MATSUURA, Matsumoto (JP)

(21) Appl. No.: 17/672,749

(22) Filed: Feb. 16, 2022

(30) Foreign Application Priority Data
Feb. 17, 2021 (JP) 2021-023173

(51) Int. Cl. B25J 9/16

(52) U.S. Cl. CPC B25J 9/1692; B25J 9/1612; B25J 9/1697; B25J 9/161

(57) ABSTRACT

A calibration method for, in a robot including a robot arm, calculating a positional relation between a first control point set in an end effector attached to the distal end of the robot arm and a second control point set further on the robot arm side than the end effector, the calibration method calculating a coordinate in a robot coordinate system of a first feature point of the robot associated with the first control point based on a first vector and a second vector calculated using an imaging section while moving the robot arm.

The present application is based on, and claims priority from JP Application Serial Number 2021-023173, filed Feb. 17, 2021, the disclosure of which is hereby incorporated by reference herein in its entirety.

### BACKGROUND

### 1. Technical Field

The present disclosure relates to a calibration method.

### 2. Related Art

For example, as described in JP-A-8-85083 (Patent Literature 1), there has been known a robot including a robot arm, to the distal end of which a tool functioning as an end effector is attached, the robot driving the robot arm to thereby perform predetermined work on a workpiece. Such a robot grasps, in a robot coordinate system, the position of a tool center point set in the tool, controls driving of the robot arm such that the tool center point moves to a predetermined position, and performs the predetermined work. Therefore, the robot needs to calculate an offset of a control point set at the distal end of the robot arm and the tool center point, that is, perform calibration.

In Patent Literature 1, the robot positions the tool center point in at least three different postures at a predetermined point on a space specified by the robot coordinate system, that is, moves the tool center point to the predetermined point. The robot calculates a position and a posture of the tool center point based on the posture of the robot arm at that time.

However, in the method disclosed in Patent Literature 1, when the tool center point is moved to the predetermined point, since the movement is performed by visual check, the tool center point and the predetermined point do not always actually coincide and variation occurs. As a result, accurate calibration cannot be performed.

### SUMMARY

A calibration method according to an aspect of the present disclosure is a calibration method for, in a robot including a robot arm, calculating a positional relation between a first control point set in an end effector attached to a distal end of the robot arm and a second control point set further on the robot arm side than the end effector, the calibration method including: a first step of imaging the robot using an imaging section and moving the robot arm to be in a first state in which a first feature point of the robot associated with the first control point is located in a predetermined position in a captured image of the imaging section and the robot arm takes a first posture; a second step of imaging the robot and moving the robot arm to be in a second state in which the first feature point is located in the predetermined position in the captured image of the imaging section and the robot arm takes a second posture; a third step of calculating a first vector that passes a position of the second control point in the first state, a first reference position obtained from a position of the second control point in the second state, and a position of the first feature point in the second state; a fourth step of rotating the robot arm centering on a reference axis that crosses an axis extending along a component of the first vector; a fifth step of moving the robot arm to be in a third state in which the first feature point is located in the predetermined position in the captured image of the imaging section and the robot arm takes a third posture; a sixth step of calculating a second vector that, in the third state, passes a second reference position obtained from a position of the second control point in the third state and a position of the first feature point in the third state; and a seventh step of calculating a coordinate of the first feature point in a robot coordinate system based on the first vector and the second vector.

### BRIEF DESCRIPTION OF THE DRAWINGS

FIG. 1 is a diagram showing an overall configuration of a robot system according to an embodiment.

FIG. 2 is a block diagram of the robot system shown in FIG. 1.

FIG. 3 is a schematic diagram showing a state in which the robot system shown in FIG. 1 is executing a calibration method according to the present disclosure.

FIG. 4 is a schematic diagram showing a state in which the robot system shown in FIG. 1 is executing the calibration method according to the present disclosure.

FIG. 5 is a schematic diagram showing a state in which the robot system shown in FIG. 1 is executing the calibration method according to the present disclosure.

FIG. 6 is a schematic diagram showing a state in which the robot system shown in FIG. 1 is executing the calibration method according to the present disclosure.

FIG. 7 is a schematic diagram showing a state in which the robot system shown in FIG. 1 is executing the calibration method according to the present disclosure.

FIG. 8 is a schematic diagram showing a state in which the robot system shown in FIG. 1 is executing the calibration method according to the present disclosure.

FIG. 9 is a schematic diagram showing a state in which the robot system shown in FIG. 1 is executing the calibration method according to the present disclosure.

FIG. 10 is a schematic diagram showing a state in which the robot system shown in FIG. 1 is executing the calibration method according to the present disclosure.

FIG. 11 is a schematic diagram showing a state in which the robot system shown in FIG. 1 is executing the calibration method according to the present disclosure.

FIG. 12 is a schematic diagram showing a state in which the robot system shown in FIG. 1 is executing the calibration method according to the present disclosure.

FIG. 13 is a schematic diagram showing a state in which the robot system shown in FIG. 1 is executing the calibration method according to the present disclosure.

FIG. 14 is a schematic diagram showing a state in which the robot system shown in FIG. 1 is executing the calibration method according to the present disclosure.

FIG. 15 is a schematic diagram showing a state in which the robot system shown in FIG. 1 is executing the calibration method according to the present disclosure.

FIG. 16 is a schematic diagram showing a state in which the robot system shown in FIG. 1 is executing the calibration method according to the present disclosure.

FIG. 17 is a schematic diagram showing a state in which the robot system shown in FIG. 1 is executing the calibration method according to the present disclosure.

FIG. 18 is a schematic diagram showing a state in which the robot system shown in FIG. 1 is executing the calibration method according to the present disclosure.

FIG. 19 is a schematic diagram showing a state in which the robot system shown in FIG. 1 is executing the calibration method according to the present disclosure.

FIG. 20 is a flowchart showing an example of an operation program executed by a control device shown in FIG. 1.

FIG. 21 is a perspective view showing an example of an end effector shown in FIG. 1.

FIG. 22 is a perspective view showing an example of the end effector shown in FIG. 1.

FIG. 23 is a perspective view showing an example of the end effector shown in FIG. 1.

FIG. 24 is a perspective view showing an example of the end effector shown in FIG. 1.

### DESCRIPTION OF EXEMPLARY EMBODIMENTS

### Embodiment

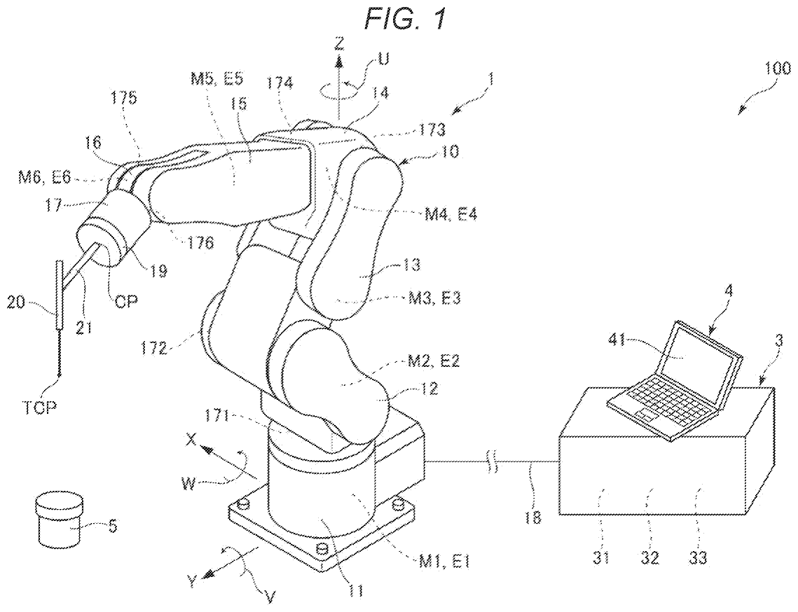

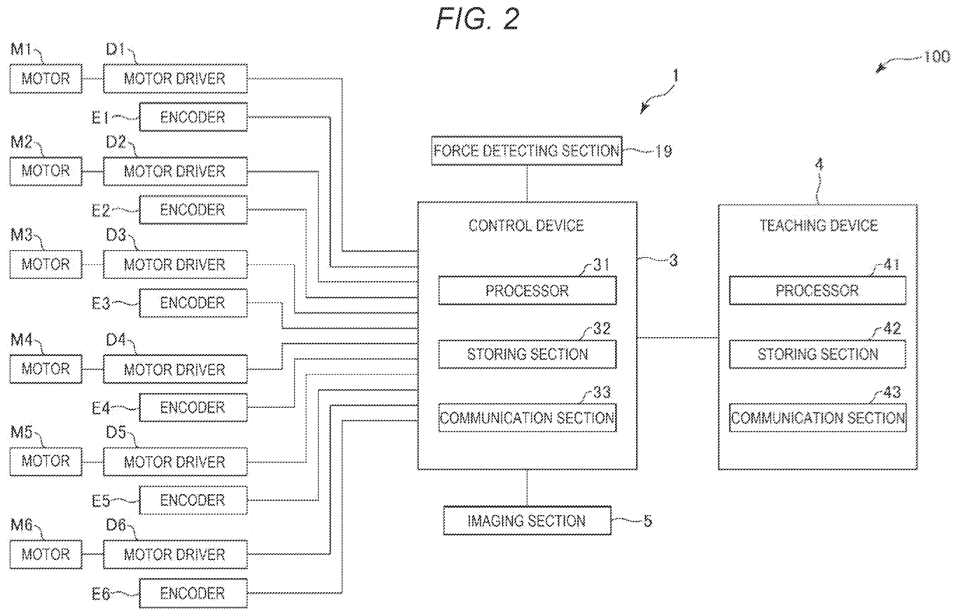

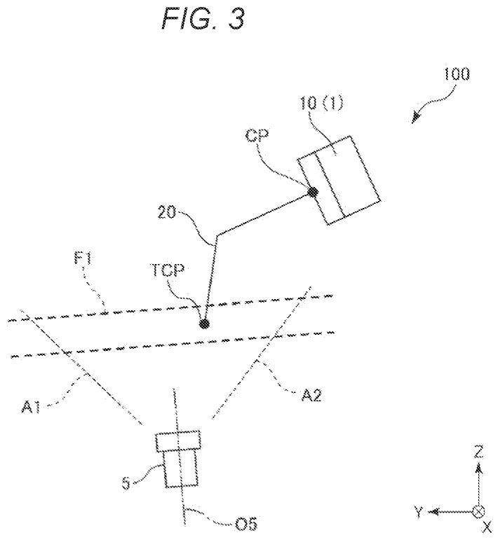

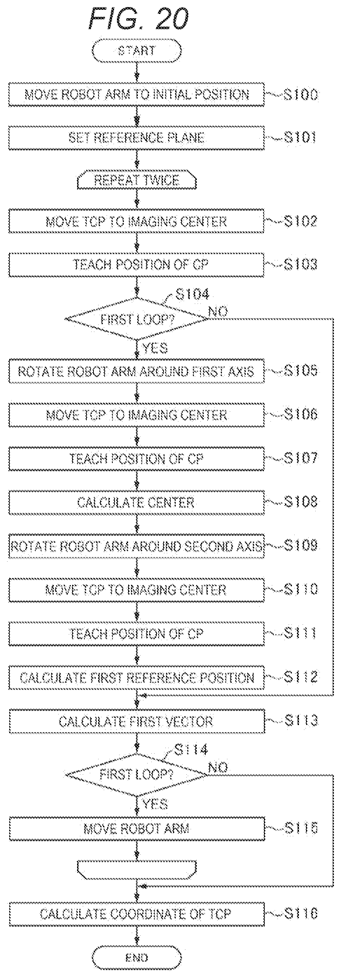

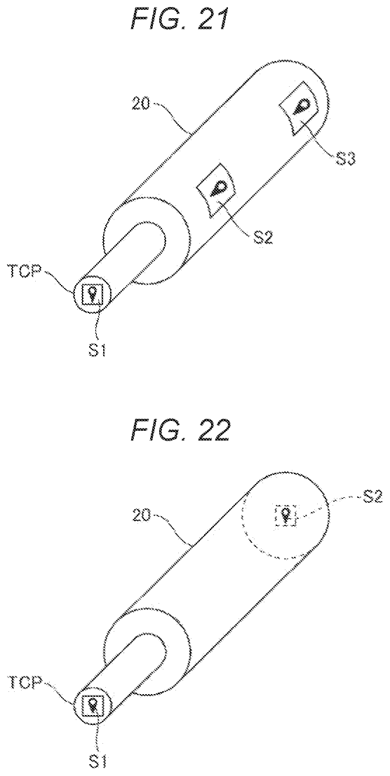

FIG. 1 is a diagram showing an overall configuration of a robot system according to an embodiment. FIG. 2 is a block diagram of the robot system shown in FIG. 1. FIGS. 3 to 19 are schematic diagrams showing states in which the robot system shown in FIG. 1 is executing a calibration method according to the present disclosure. FIG. 20 is a flowchart showing an example of an operation program executed by a control device shown in FIG. 1. FIGS. 21 to 24 are perspective views showing examples of an end effector shown in FIG. 1.

The calibration method according to the present disclosure is explained in detail below based on a preferred embodiment shown in the accompanying drawings. In the following explanation, for convenience of explanation, a +Z-axis direction, that is, the upper side in FIG. 1 is referred to as “upper” as well and a −Z-axis direction, that is, the lower side in FIG. 1 is referred to as “lower” as well. About a robot arm, an end portion on a base 11 side in FIG. 1 is referred to as “proximal end” as well and an end portion on the opposite side of the base 11 side, that is, an end effector 20 side is referred to as “distal end” as well. About the end effector and a force detecting section, an end portion on a robot arm 10 side is referred to as “proximal end” as well and an end portion on the opposite side of the robot arm 10 side is referred to as “distal end” as well. A Z-axis direction, that is, the up-down direction in FIG. 1 is represented as a “vertical direction” and an X-axis direction and a Y-axis direction, that is, the left-right direction in FIG. 1 is represented as a “horizontal direction”.

As shown in FIGS. 1 and 2, a robot system 100 includes a robot 1, a control device 3 that controls the robot 1, a teaching device 4, and an imaging section 5 and executes the calibration method according to the present disclosure.

First, the robot 1 is explained.

The robot 1 shown in FIG. 1 is a single-arm six-axis vertical articulated robot in this embodiment and includes a base 11 and a robot arm 10. An end effector 20 can be attached to the distal end portion of the robot arm 10. The end effector 20 may be a constituent element of the robot 1 or may not be the constituent element of the robot 1.

The robot 1 is not limited to the configuration shown in FIG. 1 and may be, for example, a double-arm articulated robot. The robot 1 may be a horizontal articulated robot.

The base 11 is a supporting body that supports the robot arm 10 from the lower side to be capable of driving the robot arm 10. The base 11 is fixed to, for example, a floor in a factory. In the robot 1, the base 11 is electrically coupled to the control device 3 via a relay cable 18. The coupling of the robot 1 and the control device 3 is not limited to wired coupling as in the configuration shown in FIG. 1 and may be, for example, wireless coupling or may be coupling via a network such as the Internet.

In this embodiment, the robot arm 10 includes a first arm 12, a second arm 13, a third arm 14, and a fourth arm 15, a fifth arm 16, and a sixth arm 17. These arms are coupled in this order from the base 11 side. The number of arms included in the robot arm 10 is not limited to six and may be, for example, one, two, three, four, five, or seven or more. The sizes such as the total lengths of the arms are respectively not particularly limited and can be set as appropriate.

The base 11 and the first arm 12 are coupled via a joint 171. The first arm 12 is capable of turning, with a first turning axis parallel to the vertical direction as a turning center, around the first turning axis with respect to the base 11. The first turning axis coincides with the normal of the floor to which the base 11 is fixed.

The first arm 12 and the second arm 13 are coupled via a joint 172. The second arm 13 is capable of turning with respect to the first arm 12 with a second turning axis parallel to the horizontal axis as a turning center. The second turning axis is parallel to an axis orthogonal to the first turning axis.

The second arm 13 and the third arm 14 are coupled via a joint 173. The third arm 14 is capable of turning with respect to the second arm 13 with a third turning axis parallel to the horizontal direction as a turning center. The third turning axis is parallel to the second turning axis.

The third arm 14 and the fourth arm 15 are coupled via a joint 174. The fourth arm 15 is capable of turning with respect to the third arm 14 with a fourth turning axis parallel to the center axis direction of the third arm 14 as a turning center. The fourth turning axis is orthogonal to the third turning axis.

The fourth arm 15 and the fifth arm 16 are coupled via a joint 175. The fifth arm 16 is capable of turning with respect to the fourth arm 15 with a fifth turning axis as a turning center. The fifth turning axis is orthogonal to the fourth turning axis.

The fifth arm 16 and the sixth arm 17 are coupled via a joint 176. The sixth arm 17 is capable of turning with respect to the fifth arm 16 with a sixth turning axis as a turning center. The sixth turning axis is orthogonal to the fifth turning axis.

The sixth arm 17 is a robot distal end portion located on the most distal end side in the robot arm 10. The sixth arm 17 can turn together with the end effector 20 according to driving of the robot arm 10.

The robot 1 includes a motor M1, a motor M2, a motor M3, a motor M4, a motor M5, and a motor M6 functioning as driving sections and an encoder E1, an encoder E2, an encoder E3, an encoder E4, an encoder E5, and an encoder E6. The motor M1 is incorporated in the joint 171 and relatively rotates the base 11 and the first arm 12. The motor M2 is incorporated in the joint 172 and relatively rotates the first arm 12 and the second arm 13. The motor M3 is incorporated in the joint 173 and relatively rotates the second arm 13 and the third arm 14. The motor M4 is incorporated in the joint 174 and relatively rotates the third arm 14 and the fourth arm 15. The motor M5 is incorporated in the joint 175 and relatively rotates the fourth arm 15 and the fifth arm 16. The motor M6 is incorporated in the joint 176 and relatively rotates the fifth arm 16 and the sixth arm 17.

The encoder E1 is incorporated in the joint 171 and detects the position of the motor M1. The encoder E2 is incorporated in the joint 172 and detects the position of the motor M2. The encoder E3 is incorporated in the joint 173 and detects the position of the motor M3. The encoder E4 is incorporated in the joint 174 and detects the position of the motor M4. The encoder E5 is incorporated in the joint 175 and detects the position of the motor M5. The encoder E6 is incorporated in the joint 176 and detects the position of the motor M6.

The encoders E1 to E6 are electrically coupled to the control device 3 and transmits position information, that is, rotation amounts of the motors M1 to M6 to the control device 3 as electric signals. The control device 3 drives the motors M1 to M6 via motor drivers D1 to D6 based on this information. That is, controlling the robot arm 10 means controlling the motors M1 to M6.

A control point CP is set at the distal end of a force detecting section 19 provided in the robot arm 10. The control point CP means a point serving as a reference in performing control of the robot arm 10. The robot system 100 grasps the position of the control point CP in a robot coordinate system and drives the robot arm 10 such that the control point CP moves to a desired position. That is, the control point CP is set further on the robot arm 10 side than the end effector 20. In this embodiment, the control point CP is set at the distal end of the force detecting section 19. However, if the position and the posture of the control point CP with respect to the origin of the robot coordinate system are known, the control point CP may be set in any position further on the robot arm 10 side than the end effector 20. For example, the control point CP may be set at the distal end of the robot arm 10.

In the robot 1, the force detecting section 19 that detects force is detachably set in the robot arm 10. The robot arm 10 can be driven in a state in which the force detecting section 19 is set in the robot arm 10. In this embodiment, the force detecting section 19 is a six-axis force sensor. The force detecting section 19 detects the magnitudes of forces on three detection axes orthogonal to one another and the magnitudes of torques around the three detection axes. That is, the force detecting section 19 detects force components in axial directions of an X axis, a Y axis, and a Z axis orthogonal to one another, a force component in a W direction around the X axis, a force component in a V direction around the Y axis, and a force component in a U direction around the Z axis. In this embodiment, the Z-axis direction is the vertical direction. The force components in the axial directions can be referred to as “translational force components” as well and the force components around the axes can be referred to as “torque components” as well. The force detecting section 19 is not limited to the six-axis force sensor and may be a sensor having another configuration.

In this embodiment, the force detecting section 19 is set in the sixth arm 17. A setting part of the force detecting section 19 is not limited to the sixth arm 17, that is, an arm located on the most distal end side and may be, for example, another arm or a part between arms adjacent to each other.

The end effector 20 can be detachably attached to the force detecting section 19. In this embodiment, the end effector 20 is configured by a screwdriver that screws a work target object. The end effector 20 is fixed to the force detecting section 19 via a coupling bar 21. In the configuration shown in FIG. 1, the end effector 20 is set in a direction in which the longitudinal direction of the end effector 20 crosses the longitudinal direction of the coupling bar 21.

The end effector 20 is not limited to the configuration shown in FIG. 1 and may be a tool such as a wrench, a polisher, a grinder, a cutter, or a screwdriver or may be a hand that grips a work target object with suction or clamping.

In the robot coordinate system, a tool center point TCP, which is a first control point, is set at the distal end of the end effector 20. In the robot system 100, the tool center point TCP can be set as a reference of control by grasping the position of the tool center point TCP in the robot coordinate system. The robot system 100 grasps, in the robot coordinate system, the position of the control point CP, which is a second control point, set in the robot arm 10. Accordingly, by grasping a positional relation between the tool center point TCP and the control point CP, it is possible to drive the robot arm 10 and perform work with the tool center point TCP set as the reference of the control. Grasping the positional relation between the tool center point TCP and the control point CP in this way is referred to as calibration. The calibration method according to the present disclosure explained below is a method for grasping the positional relation between the tool center point TCP and the control point CP.

Subsequently, the imaging section 5 is explained.

The imaging section 5 can be configured to include an imaging element configured by a CCD (Charge Coupled Device) image sensor including a plurality of pixels and an optical system including a lens. As shown in FIG. 2, the imaging section 5 is electrically coupled to the control device 3. The imaging section 5 converts light received by the imaging element into an electric signal and outputs the electric signal to the control device 3. That is, the imaging section 5 transmits an imaging result to the control device 3. The imaging result may be a still image or may be a moving image.

The imaging section 5 is set near a setting surface of the robot 1 and faces upward and performs imaging in the upward direction. In this embodiment, to facilitate explanation of the calibration method explained below, the imaging section 5 is set in a state in which an optical axis O5 is slightly inclined with respect the vertical direction, that is, the Z axis. A direction that the imaging section 5 faces is not particularly limited. The imaging section 5 may be disposed to face the horizontal direction, the vertical direction, and a direction crossing the horizontal direction. A disposition position of the imaging section 5 is not limited to the configuration shown in FIG. 1.

Subsequently, the control device 3 and the teaching device 4 are explained. In the following explanation in this embodiment, the control device 3 executes the calibration method according to the present disclosure. However, in the present disclosure, the calibration method is not limited to this. The teaching device 4 may execute the calibration method according to the present disclosure or the control device 3 and the teaching device 4 may share the execution of the calibration method according to the present disclosure.

As shown in FIGS. 1 and 2, in this embodiment, the control device 3 is set in a position separated from the robot 1. However, the control device 3 is not limited to this configuration and may be incorporated in the base 11. The control device 3 has a function of controlling driving of the robot 1 and is electrically coupled to the sections of the robot 1 explained above. The control device 3 includes a processor 31, a storing section 32, and a communication section 33. These sections are communicably coupled to one another via, for example, a bus.

The processor 31 is configured by, for example, a CPU (Central Processing Unit) and reads out and executes various programs and the like stored in the storing section 32. A command signal generated by the processor 31 is transmitted to the robot 1 via the communication section 33. Consequently, the robot arm 10 can execute predetermined work. In this embodiment, the processor 31 executes steps S101 to S116 explained below based on an imaging result of the imaging section 5. However, the execution of the steps is not limited to this. A processor 41 of the teaching device 4 may be configured to execute the steps S101 to S116 or the processor and the processor 41 may be configured to share the execution of steps S101 to S116.

The storing section 32 stores various programs and the like executable by the processor 31. Examples of the storing section 32 include a volatile memory such as a RAM (Random Access Memory), a nonvolatile memory such as a ROM (Read Only Memory), and a detachable external storage device.

The communication section 33 transmits and receives signals to and from the sections of the robot 1 and the teaching device 4 using an external interface such as a wired LAN (Local Area Network) or a wireless LAN.

Subsequently, the teaching device 4 is explained.

As shown in FIGS. 1 and 2, the teaching device 4 has a function of creating an operation program and inputting the operation program to the robot arm 10. The teaching device 4 includes the processor 41, a storing section 42, and a communication section 43. The teaching device 4 is not particularly limited. Examples of the teaching device 4 include a tablet terminal, a personal computer, a smartphone, and a teaching pendant.

The processor 41 is configured by, for example, a CPU (Central Processing Unit) and reads out and executes various programs such as a teaching program stored in the storing section 42. The teaching program may be a teaching program generated by the teaching device 4, may be a teaching program stored from an external recording medium such as a CD-ROM, or may be a teaching program stored via a network or the like.

A signal generated by the processor 41 is transmitted to the control device 3 of the robot 1 via the communication section 43. Consequently, the robot arm 10 can execute predetermined work under predetermined conditions.

The storing section 42 stores various programs and the like executable by the processor 41. Examples of the storing section 42 include a volatile memory such as a RAM (Random Access Memory), a nonvolatile memory such as a ROM (Read Only Memory), and a detachable external storage device.

The communication section 43 transmits and receives signals to and from the control device 3 using an external interface such as a wired LAN (Local Area Network) or a wireless LAN.

The robot system 100 is explained above.

In such a robot system 100, before the robot 1 performs the predetermined work, an operator attaches an end effector corresponding to the work to the distal end of the robot arm 10. The control device 3 or the teaching device 4 needs to grasp what kind of an end effector is attached. Even if the control device 3 or the teaching device 4 grasps a shape and a type of the attached end effector, the end effector is not always attached in a desired posture when the operator attaches the end effector. Therefore, the operator performs calibration for associating the tool center point TCP of the attached end effector 20 and the control point CP.

The calibration method according to the present disclosure is explained below with reference to FIGS. 3 to 19 and a flowchart of FIG. 20. A photographing field, that is, an imaging range of the imaging section 5 is a region on the inner side of a broken line A1 and a broken line A2 shown in FIGS. 3 to 19.

In the following explanation, in a captured image of the imaging section 5, the tool center point TCP is explained as a first feature point. That is, the tool center point TCP, which is the first control point, is recognized as a first feature point. Steps S100 to S103 are a first step, steps S105 to S111 are a second step, steps S112 and S113 are a third step, step S115 is a fourth step, step S103 in a second loop is a fifth step, step S113 in the second loop is a sixth step, and step S116 is a seventh step.

### 1. Step S100 (The First Step)

First, in step S100, as shown in FIG. 3, the processor 31 moves the robot arm 10 in a state in which the end effector 20 is inclined with respect to the Z axis and such that the tool center point TCP is located in an initial position. The initial position is any position on an imaging surface F1, which is an imaging position, that is, a focal position of the imaging section 5. The imaging surface F1 is a surface having the optical axis O5 of the imaging section 5 as a normal. In this embodiment, the imaging surface F1 is inclined with respect to an X-Y plane.

The imaging surface F1 is a plane having an optical axis of the imaging section 5 as a normal. An imageable position has predetermined width along an optical axis direction of the imaging section 5. This width is a region between two broken lines in FIG. 3. In the following explanation, “located on the imaging surface F1” refers to being located in any position in this region.

In step S100, the imaging section 5 images the tool center point TCP in motion as a video and transmits the video to the control device 3. The processor 31 grasps the tool center point TCP as the first feature point in the video transmitted from the imaging section 5 and drives the robot arm 10 such that the tool center point TCP is located in any position on the imaging surface F1.

### 2. Step S101 (The First Step)

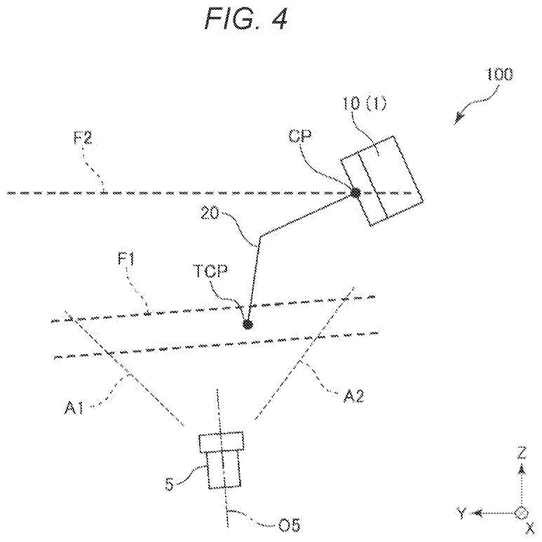

Subsequently, in step S101, the processor 31 sets a reference plane F2 as shown in FIG. 4. In this embodiment, the reference plane F2 is a plane located further on a +Z axis side than the imaging surface F1 and parallel to the X-Y plane. Setting the reference plane F2 means setting height, that is, a coordinate in the Z-axis direction of the reference plane F2 and storing the coordinate in the storing section 32. In this embodiment, the processor 31 sets the reference plane F2 in the position of the control point CP at the time when step S101 is completed.

In this embodiment, the reference plane F2 is a plane parallel to the X-Y plane. However, in the present disclosure, the reference plane F2 is not limited to this and may not be the plane parallel to the X-Y plane. For example, the reference plane F2 may be a plane parallel to an X-Z plane, may be a plane parallel to a Y-Z plane, or may be plane inclined with respect to the X-Z plane and the Y-Z plane.

In this way, the reference plane F2 is a plane parallel to a work surface on which the robot arm 10 performs work and is a plane serving as a reference when the robot arm 10 performs work. The reference plane F2 is a plane serving as a reference in changing the posture of the robot arm 10 in step S103, step S105, step S106, and step S109 explained below.

In this way, in the first step, the processor 31 sets the reference plane F2 serving as the reference in moving the robot arm 10. Consequently, it is possible to accurately and easily execute step S103, step S105, step S106, and step S109 explained below.

### 3. Step S102 (The First Step)

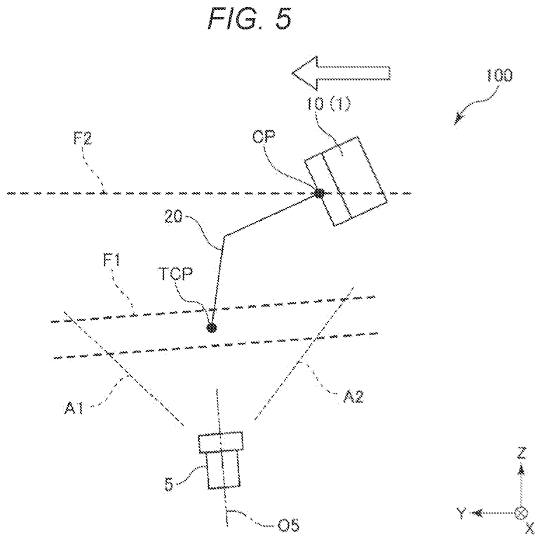

Subsequently, the processor 31 executes step S102. In step S102, as shown in FIG. 5, the processor 31 performs imaging using the imaging section 5. In this embodiment, the processor 31 drives the robot arm 10 while performing the imaging such that the tool center point TCP moves to an imaging center. In this case, the processor 31 drives the robot arm to translate the control point CP in the plane of the reference plane F2. The imaging center is an intersection of the imaging plane F1 and an optical axis O5 of the imaging section 5. In this step and subsequent steps, the processor 31 may always perform the imaging in the imaging section 5 or may perform the imaging intermittently, that is, in every predetermined time in the imaging section 5.

### 4. Step S103 (The First Step)

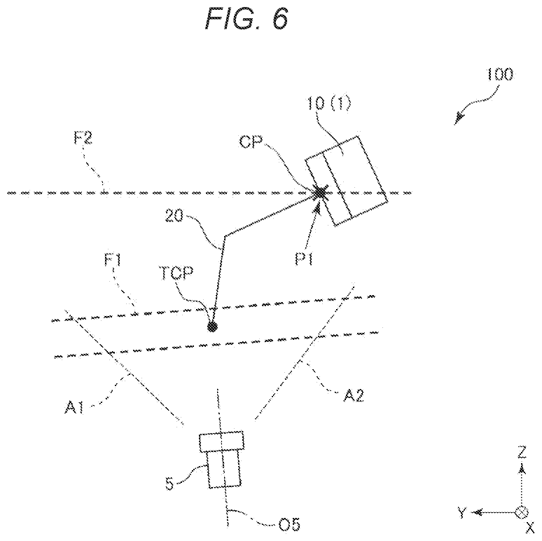

Subsequently, in step S103, as shown in FIG. 6, the processor 31 teaches a position, that is, an X coordinate, a Y coordinate, and a Z coordinate in the robot coordinate system of the control point CP at the time when the tool center point TCP is located in the imaging center. Teaching means storing in the storing section 32. The position taught in this step is referred to as position P1.

The posture of the robot arm 10 shown in FIG. 6 is a first posture. A state in which the tool center point TCP is located in the imaging center and the robot arm 10 takes the first posture is a first state. Steps S100 to S103 explained above are the first step.

Subsequently, in step S104, the processor 31 determines whether processing of the calibration method is in a first loop. The determination in this step is performed based on, for example, whether a first vector explained below is already calculated and stored. When determining in step S104 that the processing is in the first loop, the processor 31 shifts to step S105.

### 5. Step S105 (The Second Step)

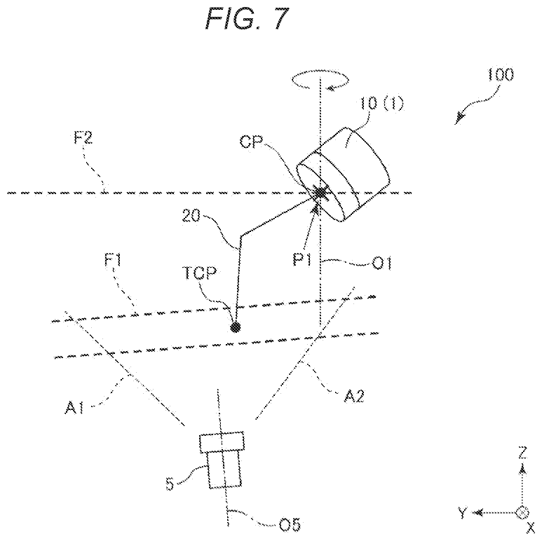

Subsequently, in step S105, as shown in FIG. 7, the processor 31 rotates the robot arm 10 around a first axis O1. The first axis O1 is a straight line passing the control point CP in the first posture and having the reference plane F2 as a normal. A rotation amount in step S105 is set to a degree at which the tool center point TCP does not deviate from an imaging range of the imaging section 5 and is set to, for example, approximately 1° or more and 60° or less.

### 6. Step S106 (The Second Step)

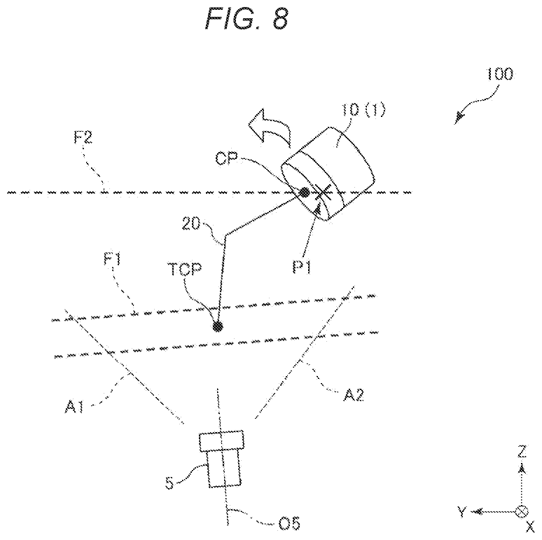

Subsequently, in step S106, as shown in FIG. 8, the processor 31 rotates the robot arm 10 around the normal of the reference plane F2 in any position such that the tool center point TCP is an imaging center in a captured image of the imaging section 5 and is located on the imaging plane F1.

### 7. Step S107 (The Second Step)

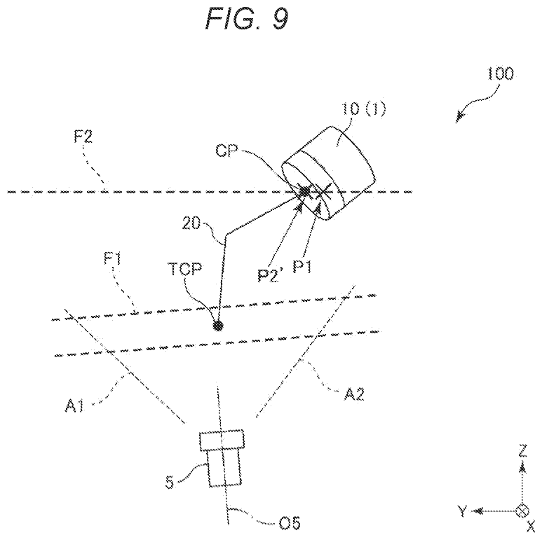

Subsequently, in step S107, as shown in FIG. 9, the processor 31 teaches a position at the time when the movement in step S106 is completed, that is, a position P2′ of the control point CP in a state in which the tool center point TCP is the imaging center in the captured image of the imaging section 5 and is located on the imaging plane F1.

### 8. Step S108 (The Second Step)

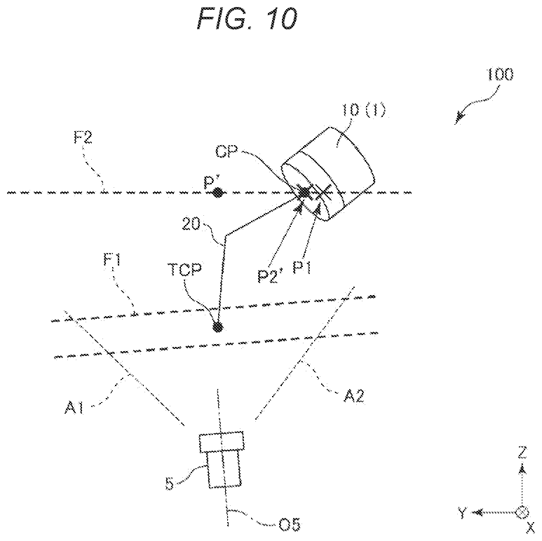

Subsequently, in step S108, as shown in FIG. 10, the processor 31 calculates a center P′ based on the position P1 and the position P2′. The center P′ is the center of a concentric circle that passes the position of the tool center point TCP at the time when the control point CP is located in the position P1 and the position of the tool center point TCP at the time when the control point CP is located in the position P2′ in the captured image of the imaging section 5.

### 9. Step S109 (The Second Step)

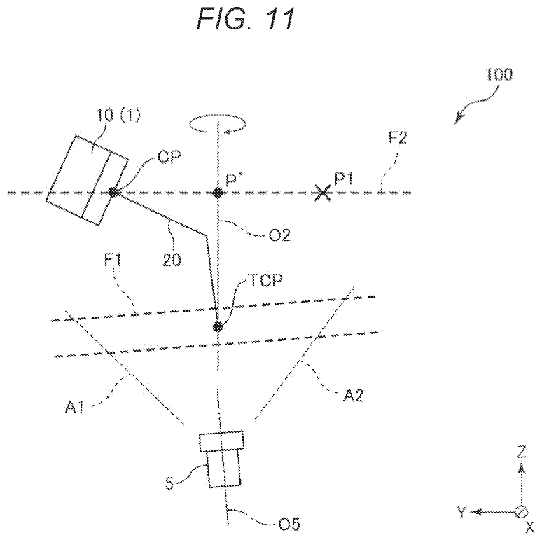

Subsequently, in step S109, as shown in FIG. 11, the processor 31 rotates the robot arm 10 around a second axis O2 passing the center P′ and parallel to the normal of the reference plane F2. A rotation amount in step S109 is preferably larger than the rotation amount in step S105 and is set to, for example, approximately 30° or more and 180° or less.

### 10. Step S110 (The Second Step)

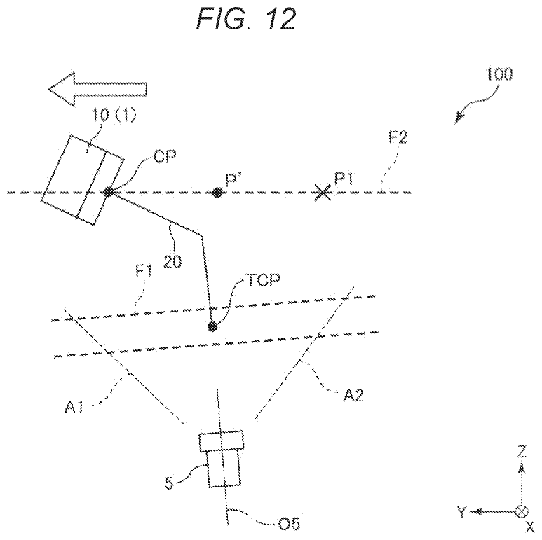

Subsequently, in step S110, as shown in FIG. 12, the processor 31 drives the robot arm 10 such that the tool center point TCP is located in the imaging center in the captured image of the imaging section 5 and on the imaging plane F1. Consequently, the robot arm 10 changes to a second state. The second state is a state in which the tool center point TCP is located in the imaging center in the captured image of the imaging section 5 and the robot arm 10 takes a second posture different from the first posture.

### 11. Step S111 (The Second Step)

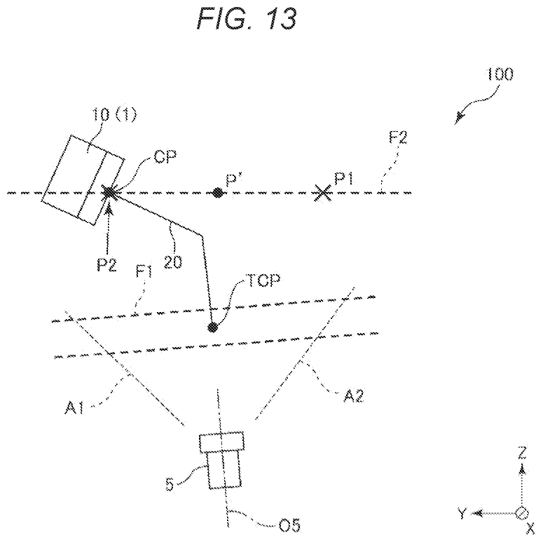

Subsequently, in step S111, as shown in FIG. 13, the processor 31 teaches a position at the time when the movement in step S110 is completed, that is, a position P2 of the control point CP in the second state. Steps S105 to S111 explained above are the second step.

In this way, in the second step, when changing the robot arm 10 from the first state to the second state, the processor 31 changes the robot arm 10 to the second state by driving the robot arm 10 such that the control point CP, which is the second control point, maintains the position in the first state and the robot arm 10 rotates centering on the first axis O1 extending along the vertical direction, driving the robot arm 10 such that the tool center point TCP, which is the first feature point, is located in the imaging center serving as a predetermined position in the captured image of the imaging section 5, driving the robot arm 10 such that the tool center point TCP rotates centering on the second axis O2 parallel to the normal of the reference plane F2, and driving the robot arm 10 such that the tool center point TCP is located in the imaging center serving as the predetermined position in the captured image of the imaging section 5. It is possible to accurately calculate a first reference position P0A explained below through such a step.

### 12. Step S112 (The Third Step)

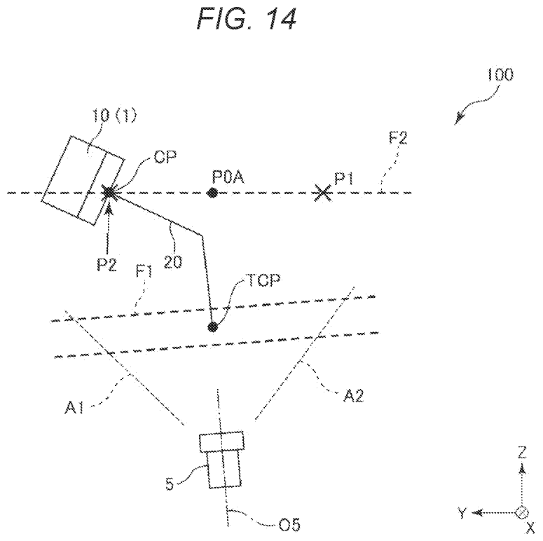

Subsequently, in step S112, as shown in FIG. 14, the processor 31 calculates a first reference position P0A from the position P1 of the control point CP in the first state and the position P2 of the control point CP in the second state. The first reference position P0A means a position serving as a reference for calculating a first vector B1 explained below. In this step, the processor 31 sets a middle point of the position P1 and the position P2 as the first reference position P0A and stores a coordinate of the first reference position P0A in the storing section 32.

### 13. Step S113 (The Third Step)

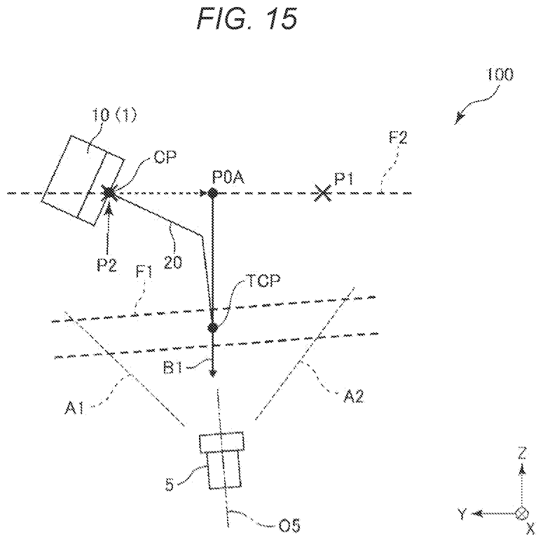

Subsequently, in step S113, as shown in FIG. 15, the processor 31 calculates a first vector B1. The first vector B1 is a straight line of a component starting from the first reference position P0A and directed toward the position of the tool center point TCP in the second state. The processor 31 stores the first vector B1 in the storing section 32.

Such steps S112 and S113 are the third step for calculating the first vector B1 passing the first reference position P0A obtained from the position P1 of the control point CP in the first state and the position P2 of the control point CP in the second state and the position of the tool center point TCP in the second state.

### 14. Step S114

Subsequently, in step S114, the processor 31 determines whether the processing is in the first loop. When determining in step S114 that the processing is in the first loop, the processor 31 shifts to step S115. When determining in step S114 that the processing is not in the first loop, that is, is in the second loop, the processor 31 shifts to step S116.

### 15. Step S115 (The Fourth Step)

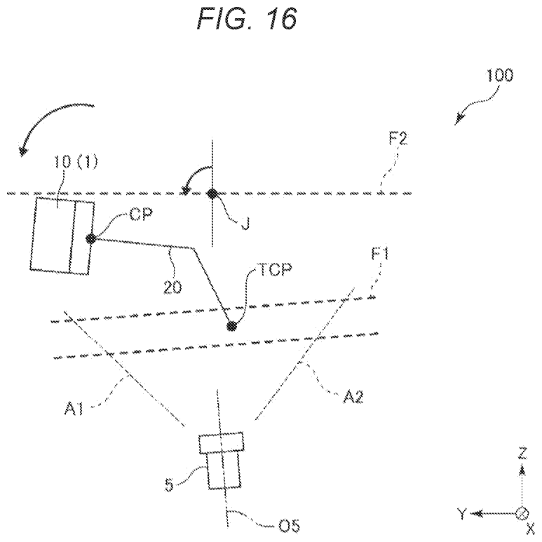

In step S115, as shown in FIG. 16, the processor 31 moves the robot arm 10 in the second state. In this step, the processor 31 drives the robot arm 10 to rotate centering on a reference axis J crossing an axis extending along the first vector B1. A rotation angle in this step is not particularly limited if the robot arm 10 is different from the second state after the rotation. The rotation angle is set to, for example, approximately 5° or more and 90° or less.

The reference axis J is an axis crossing the normal of the reference plane F2 in the configuration shown in FIG. 16. Consequently, the posture of the robot arm 10 after the fourth step can be surely differentiated from the posture of the robot arm 10 in the second state.

In the configuration shown in FIG. 16, the reference axis J is an axis crossing the normal of the reference plane F2, specifically, extending along the X-axis direction. However, the reference axis J is not limited to this configuration and may be an axis extending along the Y-axis direction or may be an axis inclined with respect to the X axis and the Y axis.

### 16. Second Loop

Returning to step S102, the processor 31 executes the second loop in a state in which the positions of the tool center point TCP and the control point CP are different from initial positions in step S100.

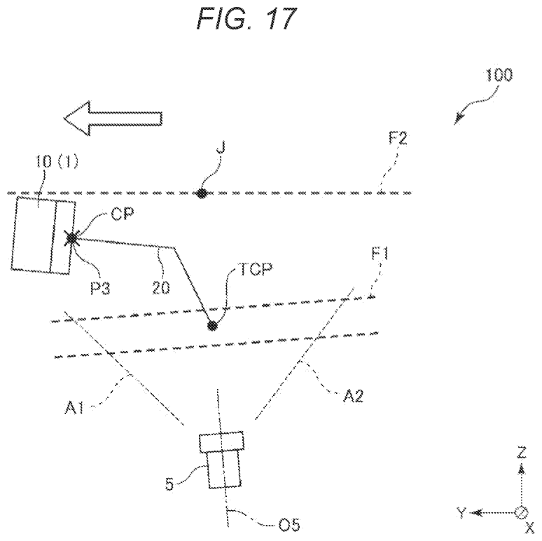

The fifth step is step S102 and step S103 in the second loop. The fifth step is a step of imaging the robot 1 using the imaging section 5 and moving the robot arm 10 such that the tool center point TCP is located in the imaging center in the captured image of the imaging section 5 and the robot arm 10 changes to a third state in which the robot arm 10 takes a third posture different from the first posture. As shown in FIG. 17, through such a fifth step, teaching of a position P3, which is the position of the control point CP in the third state, is completed.

Subsequently, in step S104, the processor 31 determines again whether the processing is in the first loop. When determining in step S104 that the processing is not in the first loop, that is, is in the second loop, the processor 31 shifts to step S113.

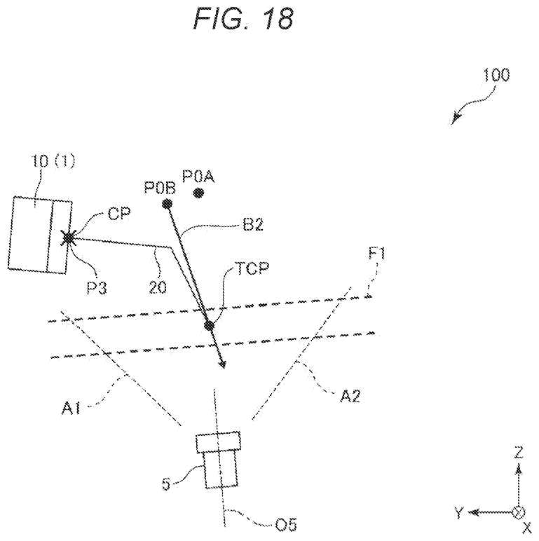

The sixth step is step S113 in the second loop. That is, as shown in FIG. 18, the processor 31 calculates a second reference position P0B obtained from the position of the control point CP in the third state. The processor 31 calculates a second vector B2 passing the second reference position P0B and the position of the tool center point TCP in the third state and stores the second vector B2 in the storing section 32. The second vector B2 is a straight line of a component starting from the second reference position P0B and directed toward the position of the tool center point TCP in the third state.

A positional relation between the position of the control point CP in the third state and the second reference position P0B is the same as a positional relation between the position P2 of the control point CP in the second state and the first reference position P0A.

### 17. Step S116 (The Seventh Step)

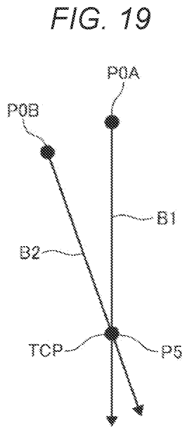

Subsequently, in step S116, as shown in FIG. 19, the processor 31 calculates a coordinate of the tool center point TCP in the robot coordinate system based on the first vector B1 and the second vector B2.

When the first vector B1 and the second vector B2 cross, the processor 31 calculates an intersection P5 of the first vector B1 and the second vector B2, calculates a coordinate (X, Y, Z) of the intersection P5, and regards the coordinate (X, Y, Z) as the position of the tool center point TCP at the time when the control point CP is located in the position P2.

On the other hand, although not shown in FIG. 19, when the first vector B1 and the second vector B2 are present in twisted positions from each other, that is, do not cross, a middle point of a portion where the first vector B1 and the second vector B2 are at the shortest distance is regarded as the position of the tool center point TCP.

The position of the control point CP and the position of the tool center point TCP can be linked, that is, associated based on the calculated positional relation between the tool center point TCP and the control point CP. Accordingly, the robot arm 10 can be driven with the position of the tool center point TCP as a reference. The predetermined work can be accurately performed.

In this way, in the seventh step, when the first vector B1 and the second vector B2 cross, a point where the first vector B1 and the second vector B2 cross is regarded as the position of the tool center point TCP, which is the first feature point. Consequently, the position of the tool center point TCP can be accurately specified. Accordingly, the predetermined work can be accurately performed.

In the seventh step, when the first vector B1 and the second vector B2 are present in the twisted positions from each other, the middle point of the portion where the first vector B1 and the second vector B2 are at the shortest distance is regarded as the position of the tool center point TCP, which is the first feature point. Consequently, even when the first vector B1 and the second vector B2 do not cross, the position of the tool center point TCP can be accurately specified. Accordingly, the predetermined work can be accurately performed.

As explained above, the present disclosure is the calibration method for calculating, in the robot 1 including the robot arm 10, a positional relation between the tool center point TCP, which is a first control point, set in the end effector 20 attached to the distal end of the robot arm 10 and the control point CP, which is a second control point, set further on the robot arm 10 side than the end effector 20. The calibration method according to the present disclosure includes a first step of imaging the robot 1 using the imaging section 5 and moving the robot arm 10 to be in a first state in which the tool center point TCP, which can be regarded as a first feature point, of the robot 1 associated with the tool center point TCP is located in a predetermined position, that is, an imaging center in a captured image of the imaging section 5 and the robot arm 10 takes a first posture, a second step of imaging the robot 1 and moving the robot arm 10 to be in a second state in which the tool center point TCP, which can be regarded as the first feature point, is located in the imaging center in a captured image of the imaging section 5 and the robot arm 10 takes a second posture, a third step of calculating the first vector B1 that passes the first reference position P0A obtained from the position P1 of the control point CP in the first state and the position P2 of the control point CP in the second state and the position of the tool center point TCP in the second state, a fourth step of rotating the robot arm 10 centering on the reference axis J that crosses an axis extending along a component of the first vector B1, a fifth step of moving the robot arm 10 to be in a third state in which the tool center point TCP, which can be regarded as the first feature point, is located in the predetermined position, that is, the imaging center in the captured image of the imaging section 5 and the robot arm 10 takes a third posture, a sixth step of calculating the second vector B2 that, in the third state, passes the second reference position P0B obtained from the position of the control point CP, which is the second control point, in the third state and the position of the tool center point TCP, which can be regarded as the first feature point, in the third state, and a seventh step of calculating a coordinate of the first feature point in a robot coordinate system based on the first vector B1 and the second vector B2.

According to such a configuration of the present disclosure, since a process in which the operator visually checks the positions of the tool center point TCP and the like is absent, more accurate calibration can be performed. A touchup process performed in the past can be omitted and a reduction in time can be achieved. It is unnecessary to prepare an imaging section having an autofocus function, an imaging section having a relatively large depth of field, and the like. It is possible to perform calibration using a relatively inexpensive imaging section.

In the above explanation, the predetermined position in the captured image of the imaging section 5 is explained as the imaging center. However, in the present disclosure, the predetermined position is not limited to this and may be any position in the captured image.

In the above explanation, as an example in which the first feature point and the tool center point TCP are associated, the case in which the first feature point and the tool center point TCP coincide is explained. However, in the present disclosure, the first feature point is not limited to this and may be any position other than the tool center point TCP of the end effector 20. A positional relation between the control point CP and the tool center point TCP may be calculated using a second feature point and a third feature point explained below.

For example, an end effector 20 shown in FIG. 21 includes a marker S1, which is the first feature point, a marker S2, which is the second feature point, and a marker S3, which is the third feature point. The marker S1 is the first feature point and is provided at the distal end portion of the end effector 20, that is, in a position corresponding to the tool center point TCP. The marker S2 is the second feature point and is provided in the center in the longitudinal direction of the end effector 20. The marker S3 is the third feature point and is provided at the proximal end portion of the end effector 20.

For example, when the position of the tool center point TCP of such an end effector 20 is grasped, the position can be grasped using either the marker S2 or the marker S3. For example, steps S101 to S116 explained above are performed with the marker S2 set as a feature point and, thereafter, steps S101 to S116 explained above are performed with the marker S3 as a feature point. Consequently, a coordinate of the marker S1 can be calculated based on a positional relation between the marker S2 and the control point CP and a positional relation between the marker S3 and the control point CP.

A posture of the end effector 20 can be calculated by calculating a positional relation between the marker S2 and the marker S3, that is, calculating a vector directed toward any point on the marker S2 from any point on the marker S3 and applying the vector to the marker S1, that is, the tool center point TCP.

For example, when the end effector 20 shown in FIGS. 22 to 24 is used, it is also possible to easily and accurately perform calibration according to the calibration method according to the present disclosure.

The end effector 20 shown in FIG. 22 includes the marker S1 and the marker S2. The marker S1 is the first feature point and is provided at the distal end portion of the end effector 20, that is, the position corresponding to the tool center point TCP. The marker S2 is the second feature point and is provided at the proximal end of the end effector 20. When such an end effector 20 is used, it is also possible to easily and accurately perform calibration according to the calibration method according to the present disclosure.

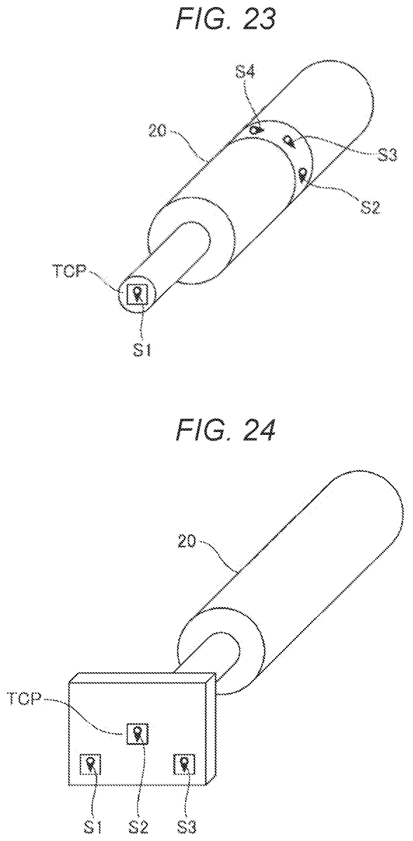

The end effector 20 shown in FIG. 23 includes the marker S1, the marker S2, the marker S3, and a marker S4. The marker S1 is the first feature point and is provided at the distal end portion of the end effector 20, that is, the position corresponding to the tool center point TCP. The marker S2 is the second feature point and is provided halfway in the longitudinal direction of the end effector 20. The marker S3 is the third feature point and is provided halfway in the longitudinal direction of the end effector 20. The marker S4 is a fourth feature point and is provided halfway in the longitudinal direction of the end effector 20. The markers S2 to S4 are disposed side by side in the circumferential direction of the end effector 20. When such an end effector 20 is used, it is also possible to easily and accurately perform calibration according to the calibration method according to the present disclosure.

The end effector 20 shown in FIG. 24 includes the marker S1, which is the first feature point, the marker S2, which is the second feature point, and the marker S3, which is the third feature point. The markers S1 to S3 are provided at the distal end portion of the end effector 20. Specifically, the markers S1 to S3 are disposed on the distal end face of the end effector 20 and in positions different from one another. When such an end effector 20 is used, it is also possible to easily and accurately perform calibration according to the calibration method according to the present disclosure.

The calibration method according to the present disclosure is explained about the illustrated embodiment. However, the present disclosure is not limited to the embodiment. The steps of the calibration method can be replaced with any steps that can exert the same functions. Any steps may be added.

When the optical axis of the imaging section and the reference plane do not perpendicularly cross and when focal lengths are different at the time when the first vector is calculated and at the time when the second vector is calculated, it is conceivable that the intersection of the first vector and the second vector relatively greatly deviate from the actual position of the tool center point. In this case, detection accuracy of the position of the first feature point shows a decreasing tendency. In order to prevent or suppress this tendency, it is preferable to drive the robot arm to be in the third posture in which focusing degrees of the imaging section coincide at the time when the first vector is calculated and at the time when the second vector is calculated. That is, it is preferable that focal positions of the first feature point in the second state in the third step and the first feature point in the third state in the sixth step coincide.

The decrease in the detection accuracy of the position of the first feature point may be suppressed by driving the robot arm to set a pixel size of the first feature point the same in step S103 in the first loop and step S103 in the second loop.

What is claimed is:

1. A calibration method for, in a robot including a robot arm, calculating a positional relation between a first control point set in an end effector attached to a distal end of the robot arm and a second control point set further on the robot arm side than the end effector, the calibration method comprising:
a first step of imaging the robot using an imaging section and moving the robot arm to be in a first state in which a first feature point of the robot associated with the first control point is located in a predetermined position in a captured image of the imaging section and the robot arm takes a first posture;
a second step of imaging the robot and moving the robot arm to be in a second state in which the first feature point is located in the predetermined position in the captured image of the imaging section and the robot arm takes a second posture;
a third step of calculating a first vector that passes a position of the second control point in the first state, a first reference position obtained from a position of the second control point in the second state, and a position of the first feature point in the second state;
a fourth step of rotating the robot arm centering on a reference axis that crosses an axis extending along a component of the first vector;
a fifth step of moving the robot arm to be in a third state in which the first feature point is located in the predetermined position in the captured image of the imaging section and the robot arm takes a third posture;
a sixth step of calculating a second vector that, in the third state, passes a second reference position obtained from a position of the second control point in the third state and a position of the first feature point in the third state; and
a seventh step of calculating a coordinate of the first feature point in a robot coordinate system based on the first vector and the second vector.

2. The calibration method according to claim 1, wherein, in the first step, a reference plane serving as a reference in moving the robot arm is set.

3. The calibration method according to claim 2, wherein the reference axis is an axis crossing a normal of the reference plane.

4. The calibration method according to claim 1, wherein, in the seventh step, when the first vector and the second vector cross, a point where the first vector and the second vector cross is regarded as the position of the first feature point.

5. The calibration method according to claim 1, wherein, in the seventh step, when the first vector and the second vector are present in twisted positions from each other, a middle point of a portion where the first vector and the second vector are at a shortest distance is regarded as the position of the first feature point.

6. The calibration method according to claim 1, wherein focal positions of the first feature point in the second state in the third step and the first feature point in the third state in the sixth step coincide.
